(19) United States
(12) Patent Application Publication
(10) Pub. No.: US 2016/0335177 A1
(43) Pub. Date: Nov. 17, 2016

(54) Cache Management Method and Apparatus

(71) Applicant: Huawei Technologies Co., Ltd., Shenzhen (CN)

(72) Inventors: Yongbing Huang, Beijing (CN); Mingyu Chen, Beijing (CN); Kun Zhang, Beijing (CN)

(21) Appl. No.: 15/218,826

(22) Filed: Jul. 25, 2016

Related U.S. Application Data
(63) Continuation of application No. PCT/CN2015/071344, filed on Jan. 22, 2015.

(30) Foreign Application Priority Data
Jan. 23, 2014 (CN) 201410032035.3

(51) Int. Cl. G06F 12/02

(52) U.S. Cl. CPC G06F 12/023; G06F 2212/1041; G06F 2212/1024; G06F 2212/282; G06F 2212/281; G06F 2212/6042; G06F 2212/608

(57) ABSTRACT

A cache management method and apparatus are disclosed, in order to improve cache resource utilization, where the method includes receiving an access request, determining data that is to be accessed and that needs to be accessed according to the access request, determining a strength level of spatial locality of the data to be accessed, and allocating, according to the strength level of the spatial locality of the data to be accessed, a cache subunit corresponding to the level to the data to be accessed, where the method is applicable to the communications field, and may used to implement cache management.

### CROSS-REFERENCE TO RELATED APPLICATION

This application is a continuation of International Application No. PCT/CN2015/071344, filed on Jan. 22, 2015, which claims priority to Chinese Patent Application No. 201410032035.3, filed on Jan. 23, 2014, both of which are hereby incorporated by reference in their entireties.

### TECHNICAL FIELD

The present disclosure relates to the communications field, and in particular, to a cache management method and apparatus.

### BACKGROUND

In a development process of computer technologies, an access speed of a main memory is always much slower than a processing speed of a central processing unit (CPU), resulting in that a high speed processing capability of the CPU cannot be fully used, and working efficiency of an entire computer system is affected. To alleviate a conflict that the speed of the CPU does not match that of the main memory, a relatively commonly used method is to use a cache in a memory hierarchy for temporary memory. For example, the cache may be integrated in the CPU such that the CPU obtains data relatively quickly. FIG. 1 is a schematic structural diagram of cache with an N-way set associated. As shown in FIG. 1, all cache lines (refer “Cacheline” in FIG. 1) in the cache have a same size, and each cache line includes a tag domain and a data domain. The tag domain is used to identify the cache line, and the data domain is used to store data to be cached. Furthermore, a specific size of the cache line is generally determined by an empirical value, and is mainly related to performance of a CPU. Higher performance of the CPU indicates a larger cache line. The size of the cache line determines a quantity of cache lines when the cache has a same capacity, and also determines power that is consumed when data is read from a memory to a cache and when data is transmitted between caches at different layers. Generally, a specification of the cache line is higher than a specification of data that is to be accessed according to a single access request.

At present, a caching mechanism of the cache includes, receiving an access request, allocating a cache line to the access request, reading, from a memory according to an address (where data corresponding to the address is data to be accessed) in the access request based on the principle of spatial locality, the data to be accessed and data of an address adjacent to an address of the data to be accessed, and writing, to the cache line that is allocated to the access request, both the data to be accessed and the data of the address adjacent to the address of the data to be accessed. The data is directly read from the cache line if data that needs to be accessed according to a next access request is already cached in the cache line, or a cache line is allocated to the next access request according to the foregoing caching mechanism, and the data is read from the memory if data that needs to be accessed according to the next access request is not cached in the cache line.

When temporary memory is performed by means of the foregoing method, the following problems exist: enough data of adjacent addresses cannot be cached in a cache line when spatial locality of data to be accessed is relatively high, resulting in that a cache line still needs to be reallocated and data still needs to be read from a memory when a subsequent access request is received. On one hand, a data read speed is affected. On the other hand, in a case in which there are limited cache lines, data in a cache line is frequently replaced, and a service life of the cache line is affected. Data cached in a cache line is probably not to be accessed according to a subsequent access request when spatial locality of data to be accessed is relatively low, causing a waste of a cache line resource, and a waste of memory bandwidth between a memory and a cache.

### SUMMARY

Embodiments of the present disclosure provide a cache management method and apparatus, which can resolve a problem of how to improve cache resource utilization.

To achieve the foregoing objective, the following technical solutions are used in the embodiments of the present disclosure.

According to a first aspect, an embodiment of the present disclosure provides a cache management method, where multiple cache subunits are disposed in a cache, and each of the cache subunits includes multiple cache lines. A length of the cache line included in each cache subunit is different from a length of a cache line included in another cache subunit. Each of the cache subunit is configured to store data at a corresponding level, the level is a strength level of spatial locality of the data, and a correspondence between the cache subunit and the level includes that the length of the cache line included in the cache subunit is in a positive correlation with strength of spatial locality of the data, and the method includes receiving an access request, determining data that is to be accessed and that needs to be accessed according to the access request, determining a strength level of spatial locality of the data to be accessed, and allocating, according to the strength level of the spatial locality of the data to be accessed, a cache subunit corresponding to the level to the data to be accessed.

With reference to the first aspect, in a first possible implementation manner, determining a strength level of spatial locality of the data to be accessed includes recording addresses of data that is to be accessed and that need to be accessed according to access requests, collecting statistics about access rules of the addresses of the data to be accessed, where the access rules includes a quantity of times or a probability that data of an address adjacent to the addresses is accessed according to another access request, and classifying, into levels according to the quantity of times or the probability that data of the address adjacent to the addresses of the data to be accessed is accessed by another access request, spatial locality of the data to be accessed.

With reference to the first possible implementation manner of the first aspect, in a second possible implementation manner, the method further includes collecting, within a preset time period, statistics about strength levels of spatial locality of data to be accessed, and calculating a first ratio, where the first ratio is used to represent a proportional relationship between or among the data to be accessed having different levels of spatial locality, calculating a second ratio, where the second ratio is used to represent a proportional relationship between or among the cache subunits in the cache that include cache lines having different lengths, and adjusting a quantity of the cache lines in the cache subunit until the difference between the second ratio and the first ratio falls within a range of the preset threshold after the adjustment when a difference between the first ratio and the second ratio is greater than a preset threshold.

With reference to the first aspect, or the first possible implementation manner of the first aspect, or the second possible implementation manner of the first aspect, in a third possible implementation manner, after receiving an access request, and determining the data that is to be accessed and that needs to be accessed according to the access request, the method further includes determining, according to the strength level of the spatial locality of the data to be accessed, a size of data to be temporarily stored, adjusting the length of the cache line in the cache subunit according to the size of the data to be temporarily stored, allocating an adjusted cache line to the data to be temporarily stored, where a length of the adjusted cache line matches the size of the data to be temporarily stored, and establishing and maintaining an index bitmap based on a change in the length of the cache line in the cache subunit, where the index bitmap is used to indicate a tag domain and a data domain that are in the cache line.

With reference to the first aspect, in a fourth possible implementation manner, that the multiple cache subunits are disposed in the cache includes dividing the cache by ways and/or by sets, to determine the multiple cache subunits, and setting the length of the cache line in each cache subunit.

With reference to the third possible implementation manner of the first aspect, in a fifth possible implementation manner, the access request includes a physical address, the physical address is used to identify the data to be accessed, and the physical address includes a tag domain and a set domain that are of the data to be accessed, and the method further includes sending the access request to each of the cache subunits, determining one or more cache lines that correspond to the set domain of the data to be accessed and that are in each of the cache subunits, comparing tag domains of the one or more cache lines with the tag domain of the data to be accessed, and determining a cache line, which has a same tag domain as the data to be accessed, in the one or more cache lines as a cache line in which the data to be accessed is stored.

With reference to the third possible implementation manner of the first aspect, in a sixth possible implementation manner, the access request includes a physical address, the physical address is used to identify the data to be accessed, and the physical address includes a tag domain and a set domain that are of the data to be accessed, and the method further includes maintaining a list for each cache subunit, where the list is used to record a characteristic value of data stored in each cache subunit, determining a characteristic value of the data that is to be accessed and that needs to be accessed according to the access request when the access request is received, determining a cache subunit, which corresponds to a list in which the characteristic value of the data to be accessed is recorded, as a target cache subunit, sending the access request to the target cache subunit, determining one or more cache lines in the target cache subunit that correspond to the set domain of the data to be accessed, comparing tag domains of the one or more cache lines with the tag domain of the data to be accessed, determining a cache line, which has a same tag domain as the data to be accessed, in the one or more cache lines as a cache line in which the data to be accessed is stored.

According to a second aspect, an embodiment of the present disclosure further provides a cache management apparatus, where the apparatus is configured to manage a cache in which multiple cache subunits are disposed, and each of the cache subunits in the cache includes multiple cache lines. A length of the cache line included in each cache subunit is different from a length of a cache line included in another cache subunit. Each of the cache subunits is configured to store data at a corresponding level, the level is a strength level of spatial locality of the data, and a correspondence between the cache subunit and the level includes that the length of the cache line included in the cache subunit is in a positive correlation with strength of spatial locality of the data, and the apparatus includes a receiving unit configured to receive an access request, a first determining unit configured to determine data that is to be accessed and that needs to be accessed according to the access request, a judging unit configured to determine a strength level of spatial locality of the data to be accessed, and an allocation unit configured to allocate, according to the strength level of the spatial locality of the data to be accessed, a cache subunit corresponding to the level to the data to be accessed.

With reference to the second aspect, in a first possible implementation manner, the judging unit includes a statistics collection module configured to record addresses of data that are to be accessed and that need to be accessed according to access requests, and collect statistics about access rules of the addresses of the data to be accessed, where the access rules include a quantity of times or a probability that data of an address adjacent to the addresses is accessed according to another access request, and a classification module configured to classify, into levels according to the quantity of times or the probability that data of the address adjacent to the addresses of the data to be accessed is accessed by another access request, spatial locality of the data to be accessed.

With reference to the first possible implementation manner of the second aspect, in a second possible implementation manner, the apparatus further includes a calculation unit configured to collect, within a preset time period, statistics about strength levels of spatial locality of data to be accessed, and calculate a first ratio, where the first ratio is used to represent a proportional relationship between or among the data to be accessed having different levels of spatial locality, and the calculation unit is further configured to calculate a second ratio, where the second ratio is used to represent a proportional relationship between or among the cache subunits in the cache that include cache lines having different lengths, and a first adjustment unit configured to adjust a quantity of the cache lines in the cache subunit until the difference between the second ratio and the first ratio falls within a range of the preset threshold after the adjustment when a difference between the first ratio and the second ratio that are obtained through calculation by the calculation unit is greater than a preset threshold.

With reference to the second aspect, or the first possible implementation manner of the second aspect, or the second possible implementation manner of the second aspect, in a third possible implementation manner, the apparatus further includes a second determining unit configured to determine, according to the strength level, which is obtained by the judging unit, of the spatial locality of the data to be accessed, a size of data to be temporarily stored, a second adjustment unit configured to adjust the length of the cache line in the cache subunit according to the size, which is determined by the second determining unit, of the data to be temporarily stored, and allocate an adjusted cache line to the data to be temporarily stored, where a length of the adjusted cache line matches the size of the data to be temporarily stored, and an index bitmap processing unit configured to establish and maintain an index bitmap based on a change in the length of the cache line in the cache subunit, where the index bitmap is used to indicate a tag domain and a data domain that are in the cache line.

With reference to the second aspect, in a fourth possible implementation manner, the apparatus further includes a division unit configured to divide the cache by ways and/or by sets, to determine the multiple cache subunits, and set the length of the cache line in each cache subunit.

With reference to the third possible implementation manner of the second aspect, in a fifth possible implementation manner, the access request received by the receiving unit includes a physical address, the physical address is used to identify the data to be accessed, and the physical address includes a tag domain and a set domain that are of the data to be accessed, and the apparatus further includes a sending unit configured to send the access request to each of the cache subunits, and a first search unit configured to determine one or more cache lines that correspond to the set domain of the data to be accessed and that are in each of the cache subunits, compare tag domains of the one or more cache lines with the tag domain of the data to be accessed, and determine a cache line, which has a same tag domain as the data to be accessed, in the one or more cache lines as a cache line in which the data to be accessed is stored.

With reference to the third possible implementation manner of the second aspect, in a sixth possible implementation manner, the access request received by the receiving unit includes a physical address, the physical address is used to identify the data to be accessed, and the physical address includes a tag domain and a set domain that are of the data to be accessed, and the apparatus further includes a list maintenance unit configured to maintain a list for each cache subunit, where the list is used to record a characteristic value of data stored in each cache subunit, a third determining unit configured to determine a characteristic value of the data that is to be accessed and that needs to be accessed according to the access request when the access request is received, a fourth determining unit configured to traverse each list maintained by the list maintenance unit, and determine a cache subunit, which corresponds to a list in which the characteristic value of the data to be accessed is recorded, as a target cache subunit, and a second search unit configured to send the access request to the target cache subunit, determine one or more cache lines in the target cache subunit that correspond to the set domain of the data to be accessed, compare tag domains of the one or more cache lines with the tag domain of the data to be accessed, and determine a cache line, which has a same tag domain as the data to be accessed, in the one or more cache lines as a cache line in which the data to be accessed is stored.

By means of the cache management method and apparatus that are provided in the embodiments, on one hand, a cache line having a relatively large length is allocated to the data to be accessed when spatial locality of data to be accessed is relatively strong. Because a probability that data of an address adjacent to the data to be accessed is accessed is relatively high when the spatial locality of the data to be accessed is relatively strong, and because the cache line allocated to the data to be accessed has a relatively large length, more data of addresses adjacent to the data to be accessed may be cached in the allocated cache line such that in a process of writing the data from a memory to a cache, a quantity of times of read and write in the cache line can be reduced, a delay for accessing the data to be cached can be reduced, and transmission bandwidth between the memory and the cache can be reduced. On the other hand, a cache line having a relatively small length is allocated to the data to be accessed when spatial locality of data to be accessed is relatively weak. Because a probability that data of an address adjacent to the data to be accessed is accessed is relatively low when the spatial locality of the data to be accessed is relatively weak, and because the cache line allocated to the data to be accessed has a relatively small length, data of only a small quantity of addresses adjacent to the data to be accessed is cached in the allocated cache line such that invalid data in the cache line is reduced, and utilization of the cache line is improved.

### BRIEF DESCRIPTION OF DRAWINGS

To describe the technical solutions in the embodiments of the present disclosure or in the prior art more clearly, the following briefly describes the accompanying drawings required for describing the embodiments or the prior art. The accompanying drawings in the following description show merely some embodiments of the present disclosure, and a person of ordinary skill in the art may still derive other drawings from these accompanying drawings without creative efforts.

FIG. 1 is a schematic hierarchy chart of a cache line;

FIG. 2 is a schematic diagram of an organization manner of cache lines in a cache that have different lengths according to Embodiment 1 of the present disclosure;

FIG. 3 is a schematic flowchart of a cache management method according to Embodiment 1 of the present disclosure;

FIG. 4 is a schematic flowchart of a cache management method according to Embodiment 2 of the present disclosure;

FIG. 5 is a schematic diagram of a spatial locality analysis module according to Embodiment 2 of the present disclosure;

FIG. 6 is a schematic flowchart of a method for changing a capacity of each cache subunit in a cache in real time according to Embodiment 2 of the present disclosure;

FIG. 7 is a schematic diagram of a correspondence between an index bitmap and a cache according to Embodiment 2 of the present disclosure;

FIG. 8 is a schematic flowchart of a cache line search method according to Embodiment 2 of the present disclosure;

FIG. 9 is a schematic flowchart of another cache line search method according to Embodiment 2 of the present disclosure;

FIG. 10 is a schematic diagram of cache types according to Embodiment 2 of the present disclosure; and

FIG. 11, FIG. 12, FIG. 13, FIG. 14, FIG. 15, and FIG. 16 are structural block diagrams of a cache management apparatus according to Embodiment 3 of the present disclosure.

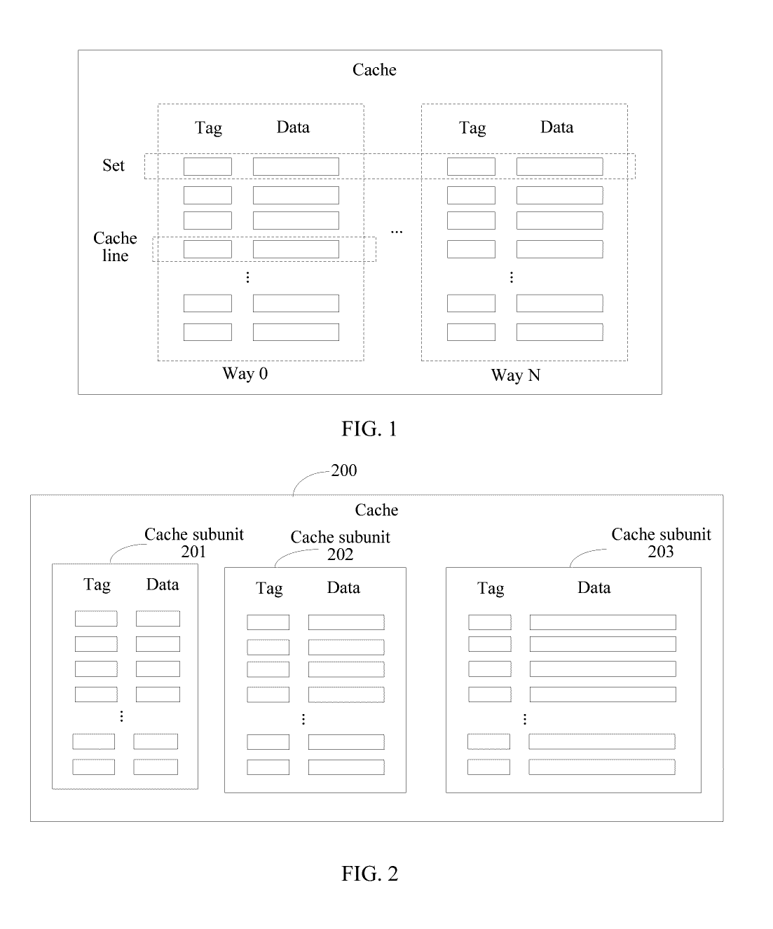

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure shall fall within the protection scope of the present disclosure.

### Embodiment 1

This embodiment provides a cache management method. In this embodiment, multiple cache subunits are disposed in a cache, and each of the cache subunits includes multiple cache lines. A length of the cache line included in each cache subunit is different from a length of a cache line included in another cache subunit. Each of the cache subunits is configured to store data at a corresponding level, the level is a strength level of spatial locality of the data, and a correspondence between the cache subunit and the level includes that the length of the cache line included in the cache subunit is in a positive correlation with strength of spatial locality of the data.

For ease of understanding, this embodiment provides a schematic diagram of an organization manner of cache lines in a cache that have different lengths for reference. As shown in FIG. 2, a cache subunit 201, a cache subunit 202, and a cache subunit 203 form a cache unit 200. The cache unit 200 may be a portion of the cache, or may be a complete cache. Each cache subunit includes multiple cache lines, and lengths of cache lines in different subunits are different. As shown in FIG. 2, a length of a cache line in the cache subunit 201 is less than a length of a cache line in the cache subunit 202, and the length of the cache line in the cache subunit 202 is less than a length of a cache line in the cache subunit 203.

It should be emphasized that the cache subunits shown in FIG. 2 are obtained after the cache is divided by ways. In an actual application, the cache may be further divided into multiple cache subunits by sets, or the cache is divided by sets in combination with by ways, and details are not described herein.

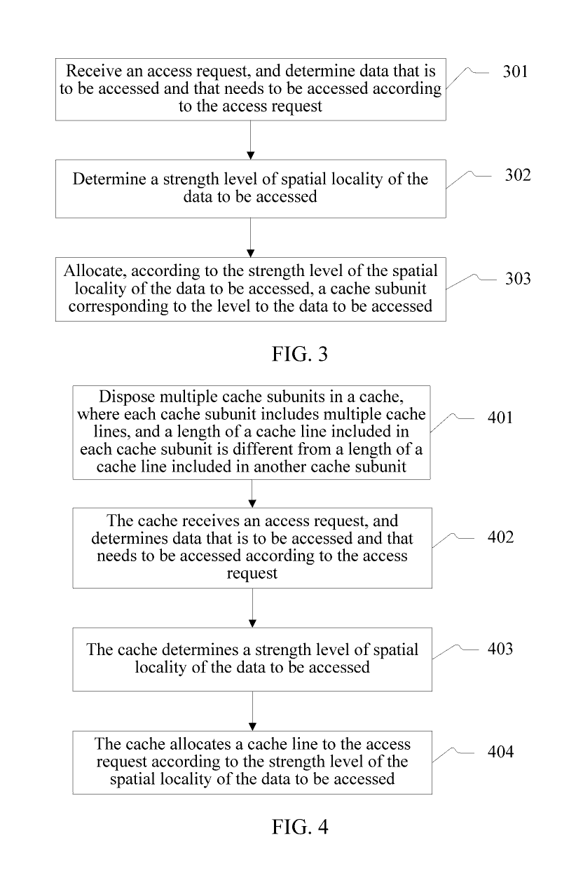

As shown in FIG. 3, the cache management method provided in this embodiment includes the following steps.

Step 301: Receive an access request, and determine data that is to be accessed and that needs to be accessed according to the access request.

The access request carries a physical address of the data to be accessed, and addressing may be performed in a memory according to the physical address, to determine the data that is to be accessed and that needs to be accessed according to the access request.

Step 302: Determine a strength level of spatial locality of the data to be accessed.

Stronger spatial locality of the data to be accessed indicates a higher probability that data of an address adjacent to the data to be accessed is accessed. Lower spatial locality of the data to be accessed indicates a lower probability that the data of the address adjacent to the data to be accessed is accessed.

Step 303: Allocate, according to the strength level of the spatial locality of the data to be accessed, a cache subunit corresponding to the level to the data to be accessed.

Furthermore, by means of step 303, a cache line having a large length is allocated to data to be accessed that has strong spatial locality, and a cache line having a small length is allocated to data to be accessed that has low spatial locality.

For example, the multiple cache subunits include at least a first cache subunit and a second cache subunit, where a length of a cache line in the first cache subunit is greater than a length of a cache line in the second cache subunit. The access request received by the cache includes at least a first access request and a second access request, where first data to be accessed needs to be accessed according to the first access request, second data to be accessed needs to be accessed according to the second access request, and spatial locality of the first data to be accessed is higher than spatial locality of the second access request. According to step 303, the cache allocates an idle cache line in the first cache subunit to the first access request, and allocates an idle cache line in the second cache subunit to the second access request.

It should be noted that the method provided in this embodiment may be implemented by a function module, where the function module may be integrated in the cache, or the method provided in this embodiment may be implemented by an independent component disposed in a terminal device, but the present disclosure is not limited thereto.

By means of the cache management method provided in this embodiment, on one hand, a cache line having a relatively large length is allocated to the data to be accessed when spatial locality of data to be accessed is relatively strong. Because a probability that data of an address adjacent to the data to be accessed is relatively high when the spatial locality of the data to be accessed is relatively strong, and because the cache line allocated to the data to be accessed has a relatively large length, more data of addresses adjacent to the data to be accessed may be cached in the allocated cache line such that in a process of writing the data from a memory to a cache, a quantity of times of read and write in the cache line can be reduced, a delay for accessing the data to be cached can be reduced, and transmission bandwidth between the memory and the cache can be reduced. On the other hand, a cache line having a relatively small length is allocated to the data to be accessed when spatial locality of data to be accessed is relatively weak. Because a probability that data of an address adjacent to the data to be accessed is relatively low when the spatial locality of the data to be accessed is relatively weak, and because the cache line allocated to the data to be accessed has a relatively small length, data of only a small quantity of addresses adjacent to the data to be accessed is cached in the allocated cache line such that invalid data in the cache line is reduced, and utilization of the cache line is improved.

### Embodiment 2

Based on the embodiment shown in FIG. 3, this embodiment of the present disclosure further provides a cache management method. As shown in FIG. 4, the method provided in this embodiment includes the following steps.

Step 401: Dispose multiple cache subunits in a cache, where each cache subunit includes multiple cache lines, and a length of the cache line included in each cache subunit is different from a length of a cache line included in another cache subunit.

The cache may be divided by ways, to determine the multiple cache subunits, and the length of the cache line in each cache subunit is set, and/or the cache is divided by sets, to determine the multiple cache subunits, and the length of the cache line in each cache subunit is set.

Step 402: The cache receives an access request, and determines data that is to be accessed and that needs to be accessed according to the access request.

It should be noted that the method provided in this embodiment may be implemented by a function module, where the function module may be integrated in the cache, or the method provided in this embodiment may be implemented by disposing an independent component in a terminal device, but the present disclosure is not limited thereto.

For ease of understanding, this embodiment is described in a form of the function module, that is, a corresponding function module is disposed in the cache, and the function module is configured to manage the cache.

Step 403: The cache determines a strength level of spatial locality of the data to be accessed.

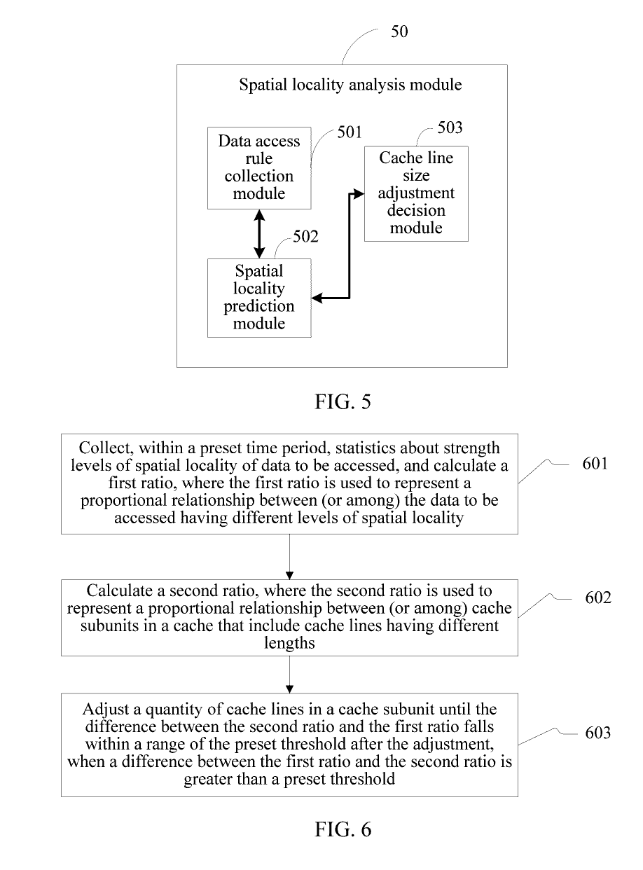

A spatial locality analysis module may be disposed in the cache to determine the strength level of the spatial locality of the data to be accessed. As shown in FIG. 5, the spatial locality analysis module 50 includes a data access rule collection module 501, a spatial locality prediction module 502, and a cache line size adjustment decision module 503. Step 403 is implemented by the spatial locality analysis module 50 using the following steps.

Step S1: The data access rule collection module 501 records addresses of data that is to be accessed and that needs to be accessed according to access requests, and collects statistics about access rules of the addresses, which further includes collecting statistics about a quantity of times or a probability that data of an address adjacent to the data that is to be accessed and that needs to be accessed by each access request is accessed according to another access request.

Step S2: The spatial locality prediction module 502 predicts, according to the access rule, the spatial locality of the data to be accessed, which further includes classifying, into levels according to the quantity of times or the probability that data of the address adjacent to the data to be accessed is accessed by another access request, spatial locality of the data to be accessed.

For example, two determining thresholds T1 and T2 may be preset, where T1 is less than T2. It is determined that the spatial locality of the data to be accessed is “low” when the quantity of times or the probability that the data of the address adjacent to the data to be accessed is accessed by the other access request is lower than T1, or it is determined that the spatial locality of the data to be accessed is “medium” when the quantity of times or the probability that the data of the address adjacent to the data to be accessed is accessed by the other access request reaches T1, but does not reach T2, or it is determined that the spatial locality of the data to be accessed is “high” when the quantity of times or the probability that the data of the address adjacent to the data to be accessed is accessed by the other access request reaches T2.

Step 404: The cache allocates a cache line to the access request according to the strength level of the spatial locality of the data to be accessed.

A cache line having a large length is allocated to data to be accessed that has strong spatial locality, and a cache line having a small length is allocated to data to be accessed that has weak spatial locality. For example (with reference to the FIG. 2), the cache subunits are sorted according to a descending order of lengths of cache lines, which are sequentially the cache subunit 203, the cache subunit 202, and the cache subunit 201. Based on an organization manner of cache lines shown in FIG. 2, an idle cache line in the cache subunit 203 is allocated to the corresponding access request when it is determined in step 403 that the spatial locality of the data to be accessed is “high”, or an idle cache line in the cache subunit 202 is allocated to the corresponding access request when the spatial locality of the data to be accessed is “medium”, or an idle cache line in the cache subunit 201 is allocated to the corresponding access request when the spatial locality of the data to be accessed is “low”.

By means of the foregoing steps, on one hand, when spatial locality of data to be accessed is relatively high, the data to be accessed and data of an address adjacent to the data to be accessed may be both determined as data to be cached (where higher spatial locality of the data to be accessed indicates larger data that is to be cached and that corresponds to the data to be accessed), and the data to be cached is cached in a pre-allocated cache line. Because the pre-allocated cache line has a relatively large length, in a process of writing, from a memory to a cache, the data to be cached, a quantity of times of read and write in the cache line can be reduced such that a delay for accessing the data to be cached is reduced, and transmission bandwidth between the memory and the cache is reduced. On the other hand, the data to be accessed may be determined as data to be cached (or the data to be accessed and a small quantity of data of addresses adjacent to the data to be accessed are both determined as the data to be cached), and the data to be cached is cached in a pre-allocated cache line allocated in advance when spatial locality of data to be accessed is relatively low. Because the pre-allocated cache line has a relatively small length, invalid data in the cache line can be reduced, and utilization of the cache line can be improved.

In this embodiment, the organization manner of the cache lines in the cache may be fixed, and capacities of the cache subunits 201 to 203 in FIG. 2 is fixed. By means of the method, utilization of a cache line can be improved, and relatively low complexity of a cache can be further ensured, facilitating implementation.

Optionally, in an optimized solution, capacities of the cache subunits in the cache may be further changed in real time according to strength levels of spatial locality of data to be accessed that corresponds to multiple access requests received within a preset time period, to further improve utilization of the cache line. Details are shown in FIG. 6 using the following steps.

Step 601: Collect, within a preset time period, statistics about strength levels of spatial locality of data to be accessed, and calculate a first ratio, where the first ratio is used to represent a proportional relationship between (or among) the data to be accessed having different levels of spatial locality.

Step 602: Calculate a second ratio, where the second ratio is used to represent a proportional relationship between (or among) cache subunits in a cache that include cache lines having different lengths.

Step 603: Adjust a quantity of cache lines in a cache subunit until the difference between the second ratio and the first ratio falls within a range of the preset threshold after the adjustment when a difference between the first ratio and the second ratio is greater than a preset threshold.

For ease of understanding, the foregoing steps 601 to 603 are illustrated based on the organization manner of cache lines shown in FIG. 2. For example, by means of step 601, it is determined that a proportional relationship between (or among) the capacities of the cache subunits in the cache is the cache subunit 201: the cache subunit 202: the cache subunit 203=1:1:1.

By means of step 602, it is determined that a proportional relationship between (or among) quantities of the access requests, which are received by the cache within the preset time period, having different spatial locality is access request having “high” spatial locality : access request having “medium” spatial locality : access request having “low” spatial locality=1:2:3.

Based on the foregoing case, a proportion of each cache subunit in the entire cache may be adjusted by means of step 603 such that the proportional relationship between (or among) the capacities of the cache subunits in the cache is changed to: the cache subunit 201 : the cache subunit 202 : the cache subunit 203=1:2:3.

It may be avoided that data having relatively strong (or relatively weak) spatial locality is written to a cache line having a relatively small (or relatively large) length through the foregoing processing such that utilization of the cache line in each cache subunit is further improved.

The method shown in FIG. 6 may be implemented using the cache line size adjustment decision module 503 in FIG. 5.

In another optimized solution, based on the cache management method shown in FIG. 4, after the spatial locality of the data to be accessed is determined by means of step 403, step 404 may be replaced with the following method which includes the following steps.

Step S1: Determine, according to the strength level of the spatial locality of the data to be accessed, a size of data to be cached.

The data to be accessed and multiple pieces of data of addresses adjacent to the data to be accessed may be both determined as the data to be cached, when the spatial locality of the data to be accessed is relatively strong, or only the data to be accessed may be determined as the data to be cached (or the data to be accessed and a small quantity of data of addresses adjacent to the data to be accessed are determined together as the data to be cached) when the spatial locality of the data to be accessed is relatively weak.

Step S2: Adjust a length of a cache line in the cache subunit according to the size of the data to be cached, and allocate an adjusted cache line to the data to be cached, where a length of the adjusted cache line matches the size of the data to be cached.

Step S3: Establish and maintain an index bitmap based on a change in the length of the cache line in the cache subunit, where the index bitmap is used to indicate a tag domain and a data domain that are in the cache line.

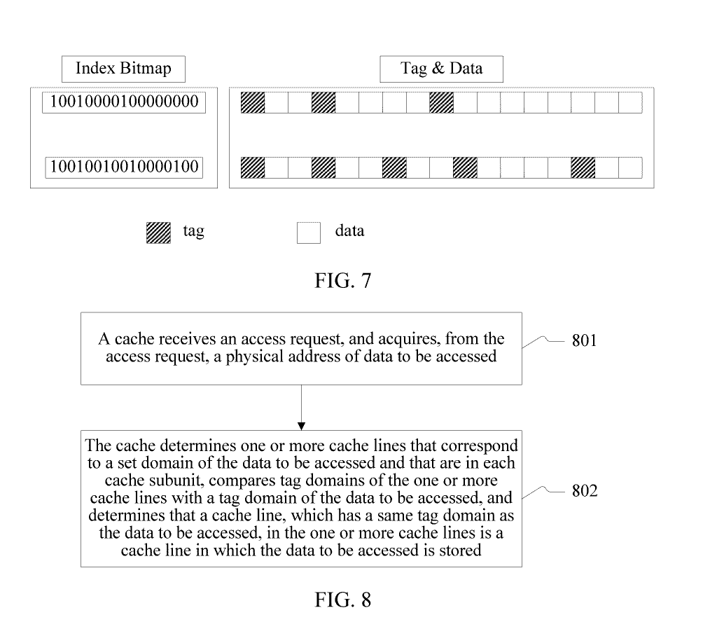

For ease of understanding, this embodiment provides a schematic diagram of an index bitmap, and a cache line corresponding to the index bitmap for reference. For example, as shown in FIG. 7, “0” in the index bitmap represents that a corresponding byte block is data, and “1” in the index bitmap represents that a corresponding byte block is a tag, where a start byte and an end byte that are of corresponding data to be cached are recorded in the tag. It should be noted that the index bitmap is configurable, and not only may be provided to an operating system or a user using a register or a port or in another manner, but also may interact with a system or a user in another manner.

By means of the foregoing steps S1 to S3, the corresponding cache line can be allocated, according to the size of the data to be cached, to the data to be cached such that a cache line resource can be fully used.

According to the foregoing description, a cache line can be allocated to an access request according to a strength level of spatial locality of data to be accessed. Based on a cache line allocation solution provided in this embodiment, this embodiment further provides a cache line search solution, and details are shown in following steps.

In a solution 1, as shown in FIG. 8:

Step 801: A cache receives an access request, and acquires, from the access request, a physical address of data to be accessed.

The access request includes the physical address, the physical address is used to identify the data to be accessed, and the physical address includes a tag domain and a set domain that are of the data to be accessed, where the tag domain is an identifier of the data to be accessed, and the set domain is used to represent a set to which the data to be accessed belongs in the cache.

Step 802: The cache determines one or more cache lines that correspond to a set domain of the data to be accessed and that are in each cache subunits, compares tag domains of the one or more cache lines with a tag domain of the data to be accessed, and determines that a cache line, which has a same tag domain as the data to be accessed, in the one or more cache lines as a cache line in which the data to be accessed is stored.

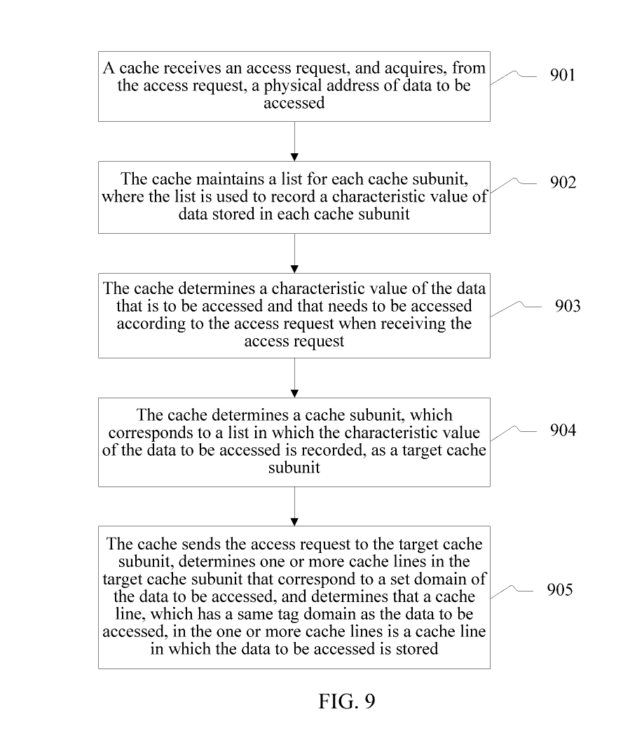

In a solution 2, as shown in FIG. 9:

Step 901: A cache receives an access request, and acquires, from the access request, a physical address of data to be accessed.

The access request includes the physical address, the physical address is used to identify the data to be accessed, and the physical address includes a tag domain and a set domain that are of the data to be accessed, where the tag domain is an identifier of the data to be accessed, and the set domain is used to represent a set to which the data to be accessed belongs in the cache.

Step 902: The cache maintains a list for each cache subunit, where the list is used to record a characteristic value of data stored in each cache subunit.

The characteristic value is used to identify the data stored in the cache subunit, that is, there is a correspondence between the characteristic value and the data. For example, physical addresses of data may be calculated using a hash function, and values obtained through calculation are determined as characteristic values corresponding to the data.

Step 903:The cache determines a characteristic value of the data that is to be accessed and that needs to be accessed according to the access request when receiving the access request.

Step 904: The cache determines a cache subunit, which corresponds to a list in which the characteristic value of the data to be accessed is recorded, as a target cache subunit.

Step 905: The cache sends the access request to the target cache subunit, determines one or more cache lines in the target cache subunit that correspond to a set domain of the data to be accessed, compares tag domains of the one or more cache lines with a tag domain of the data to be accessed, and determines a cache line, which has a same tag domain as the data to be accessed, in the one or more cache lines as a cache line in which the data to be accessed is stored.

A cache line search can be implemented using the methods shown in FIG. 8 and FIG. 9.

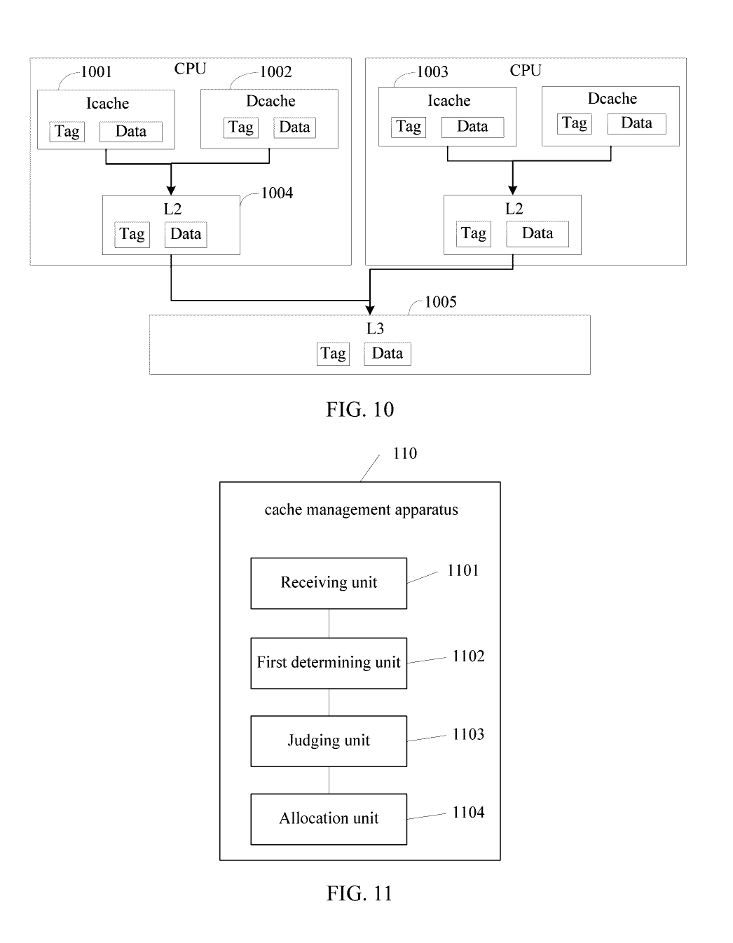

It should be noted that the cache management method provided in this embodiment is applicable to different types of caches. FIG. 10 provides an organization manner in which cache lines having different sizes are used in different types of caches. As shown in FIG. 10, different types of caches include the following multiple cases:

(1) caches having different functions in a same CPU, such as an instruction cache (Icache) 1001 and a data cache (Dcache) 1002;

(2) caches at different layers but in a same CPU, such as an Icache 1001 and an L2 cache 1004;

(3) caches at a same layer but in different CPUs, such as an Icache 1001 and an Icache 1003; and

(4) a private cache and a shared cache in different CPUs, such as an L3 cache 1005 and another cache unit.

The foregoing different types of caches may be configured using same cache lines or different cache lines, and a specific configuration case may be set as required.

### Embodiment 3

This embodiment of the present disclosure provides a cache management apparatus, which may implement a cache management method provided in the present disclosure.

The apparatus provided in this embodiment is configured to manage a cache in which multiple cache subunits are disposed, and each of the cache subunits in the cache includes multiple cache lines. A length of the cache line included in each cache subunit is different from a length of a cache line included in another cache subunit. Each of the cache subunits is configured to store data at a corresponding level, the level is a strength level of spatial locality of the data, and a correspondence between the cache subunit and the level includes that the length of the cache line included in the cache subunit is in a positive correlation with strength of spatial locality of the data.

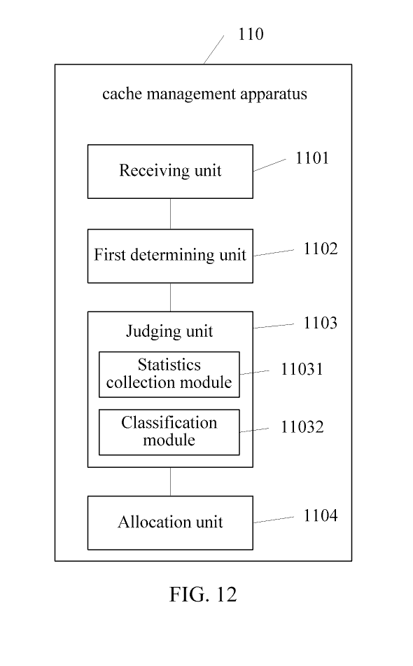

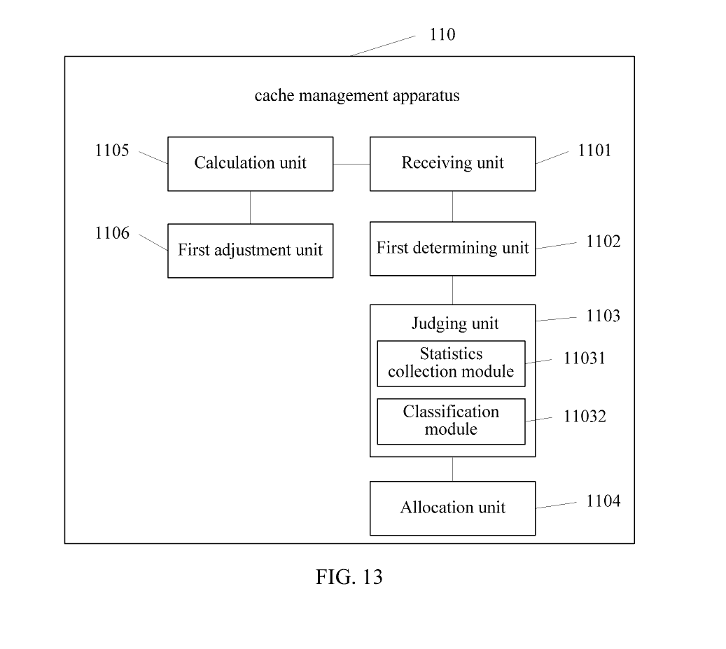

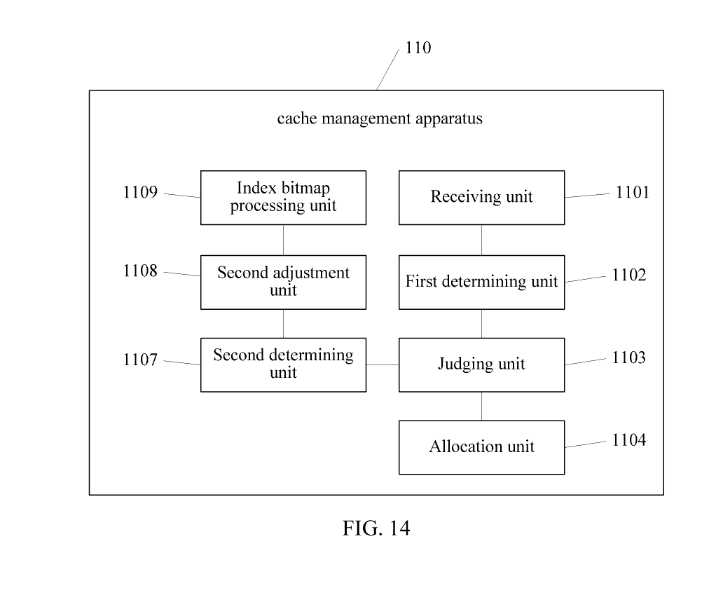

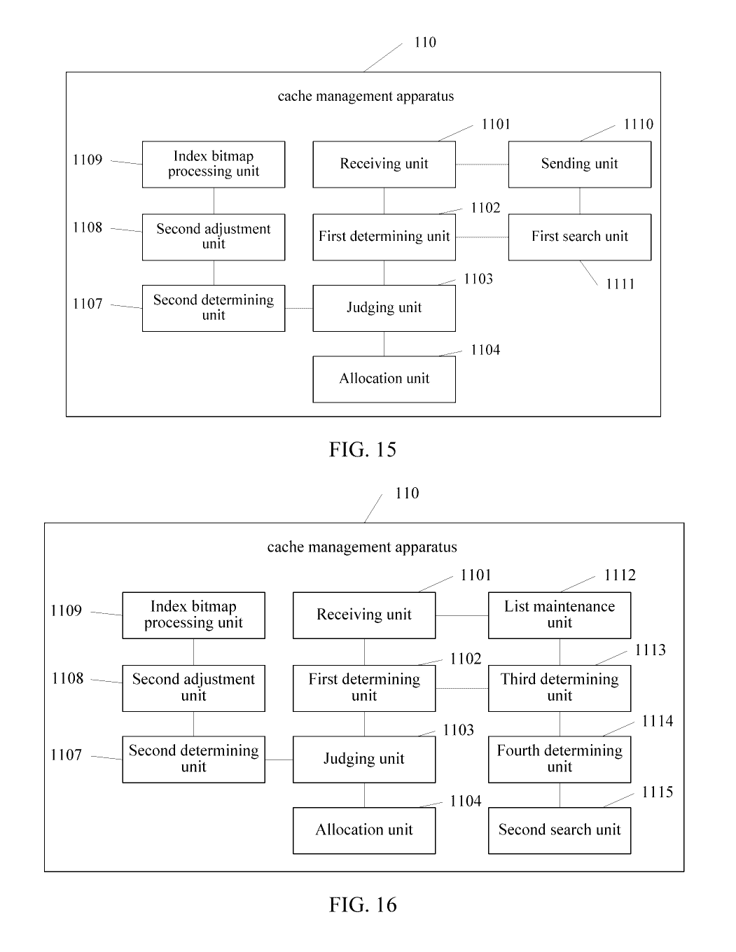

As shown in FIG. 11, the cache management apparatus 110 provided in this embodiment includes a receiving unit 1101 configured to receive an access request, a first determining unit 1102 configured to determine data that is to be accessed and that needs to be accessed according to the access request, a judging unit 1103 configured to determine a strength level of spatial locality of the data to be accessed, and an allocation unit 1104 configured to allocate, according to the strength level of the spatial locality of the data to be accessed, a cache subunit corresponding to the level to the data to be accessed.

Further, as shown in FIG. 12, the judging unit 1103 of the cache management apparatus 110 includes a statistics collection module 11031 configured to record addresses of data that is to be accessed and that needs to be accessed according to access requests, and collect statistics about access rules of the addresses of the data to be accessed, where the access rules includes a quantity of times or a probability that data of an address adjacent to the addresses is accessed according to another access request, and a classification module 11032 configured to classify, into levels according to the quantity of times or the probability that data of the address adjacent to the addresses of the data to be accessed is accessed by another access request, spatial locality of the data to be accessed.

As shown in FIG. 13, the cache management apparatus 110 further includes a calculation unit 1105 configured to collect, within a preset time period, statistics about strength levels of spatial locality of data to be accessed, and calculate a first ratio, where the first ratio is used to represent a proportional relationship between or among the data to be accessed having different levels of spatial locality, where the calculation unit 1105 is further configured to calculate a second ratio, where the second ratio is used to represent a proportional relationship between or among the cache subunits in the cache that include cache lines having different lengths, and a first adjustment unit 1106 configured to adjust a quantity of the cache lines in the cache subunit until the difference between the second ratio and the first ratio falls within a range of the preset threshold after the adjustment when a difference between the first ratio and the second ratio that are obtained through calculation by the calculation unit 1105 is greater than a preset threshold.

Based on FIG. 11 to FIG. 13, further, as shown in FIG. 14, the cache management apparatus 110 further includes a second determining unit 1107 configured to determine, according to the strength level, which is obtained by the judging unit 1103, of the spatial locality of the data to be accessed, a size of data to be cached, a second adjustment unit 1108 configured to adjust a length of a cache line in the cache subunit according to the size, which is determined by the second determining unit 1107, of the data to be cached, and allocate an adjusted cache line to the data to be cached, where a length of the adjusted cache line matches the size of the data to be cached, and an index bitmap processing unit 1109 configured to establish and maintain an index bitmap based on a change in the length of the cache line in the cache subunit, where the index bitmap is used to indicate a tag domain and a data domain that are in the cache line.

It should be noted that for brevity of description, some units and modules added in FIG. 12 and FIG. 13 are not embodied in FIG. 14, but the apparatus in FIG. 14 may include some units and modules added in FIG. 12 and FIG. 13.

Optionally, the cache management apparatus 110 may further include a division unit configured to divide the cache by ways and/or by sets, to determine the multiple cache subunits, and set the length of the cache line in each cache subunit.

In FIG. 11, FIG. 12, FIG. 13, and FIG. 14, the access request received by the receiving unit 1101 includes a physical address, where the physical address is used to identify the data to be accessed, and the physical address includes a tag domain and a set domain that are of the data to be accessed.

Based on FIG. 14, further, as shown in FIG. 15, the cache management apparatus 110 further includes a sending unit 1110 configured to send the access request to each of the cache subunits, and a first search unit 1111 configured to determine one or more cache lines that correspond to the set domain of the data to be accessed and that are in each of the cache subunits, compare tag domains of the one or more cache lines with the tag domain of the data to be accessed, and determine a cache line, which has a same tag domain as the data to be accessed, in the one or more cache lines as a cache line in which the data to be accessed is stored.

Based on FIG. 14, further, as shown in FIG. 16, the cache management apparatus 110 further includes a list maintenance unit 1112 configured to maintain a list for each cache subunit, where the list is used to record a characteristic value of data stored in each cache subunit, a third determining unit 1113 configured to determine a characteristic value of the data that is to be accessed and that needs to be accessed according to the access request when the access request is received, a fourth determining unit 1114 configured to traverse each list maintained by the list maintenance unit, and determine a cache subunit, which corresponds to a list in which the characteristic value of the data to be accessed is recorded, as a target cache subunit, and a second search unit 1115 configured to send the access request to the target cache subunit, determine one or more cache lines in the target cache subunit that correspond to the set domain of the data to be accessed, compare tag domains of the one or more cache lines with the tag domain of the data to be accessed, and determine a cache line, which has a same tag domain as the data to be accessed, in the one or more cache lines as a cache line in which the data to be accessed is stored.

By means of the cache management apparatus provided in this embodiment, on one hand, a cache line having a relatively large length is allocated to the data to be accessed when spatial locality of data to be accessed is relatively strong. Because a probability that data of an address adjacent to the data to be accessed is relatively high when the spatial locality of the data to be accessed is relatively strong, and because the cache line allocated to the data to be accessed has a relatively large length, more data of addresses adjacent to the data to be accessed may be cached in the allocated cache line such that in a process of writing the data from a memory to a cache, a quantity of times of read and write in the cache line can be reduced, a delay for accessing the data to be cached can be reduced, and transmission bandwidth between the memory and the cache can be reduced. On the other hand, a cache line having a relatively small length is allocated to the data to be accessed when spatial locality of data to be accessed is relatively weak. Because a probability that data of an address adjacent to the data to be accessed is relatively low when the spatial locality of the data to be accessed is relatively weak, and because the cache line allocated to the data to be accessed has a relatively small length, data of only a small quantity of addresses adjacent to the data to be accessed is cached in the allocated cache line such that invalid data in the cache line is reduced, and utilization of the cache line is improved.

Based on the foregoing descriptions of the implementation manners, a person skilled in the art may clearly understand that the present disclosure may be implemented by software in addition to necessary universal hardware or by hardware only. In most circumstances, the former is a preferred implementation manner. Based on such an understanding, the technical solutions of the present disclosure essentially or the part contributing to the prior art may be implemented in a form of a software product. The software product is stored in a readable storage medium, such as a floppy disk, a hard disk or an optical disc of a computer, and includes several instructions for instructing a computer device (which may be a personal computer, a server, or a network device) to perform the methods described in the embodiments of the present disclosure.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A cache management method, wherein multiple cache subunits are disposed in a cache, wherein each cache subunit of the multiple cache subunits comprises multiple cache lines, wherein a length of a cache line comprised in each of the cache subunits is different from a length of a cache line comprised in another cache subunit, wherein each of the cache subunits is configured to store data at a corresponding level, wherein the corresponding level is a strength level of spatial locality of the data, wherein a correspondence between the cache subunit and the corresponding level comprises that the length of the cache line comprised in the cache subunit is in a positive correlation with strength of the spatial locality of the data, and wherein the method comprises:
receiving an access request;
determining data that is to be accessed and that needs to be accessed according to the access request;
determining a strength level of spatial locality of the data to be accessed; and
allocating, according to the strength level of the spatial locality of the data to be accessed, a cache subunit corresponding to the level to the data to be accessed.

2. The method according to claim 1, wherein determining the strength level of the spatial locality of the data to be accessed comprises:
recording addresses of data that is to be accessed and that needs to be accessed according to access requests;
collecting statistics about access rules of the addresses of the data to be accessed, wherein an access rule comprises a quantity of times or a probability that data of an address adjacent to the addresses is accessed according to another access request; and
classifying, into levels according to the quantity of times or the probability that the data of the address adjacent to the addresses of the data to be accessed is accessed by another access request, the spatial locality of the data to be accessed.

3. The method according to claim 2, further comprising:
collecting, within a preset time period, the statistics about the strength levels of the spatial locality of the data to be accessed;
calculating a first ratio, wherein the first ratio is used to represent a proportional relationship between or among the data to be accessed having different levels of the spatial locality;
calculating a second ratio, wherein the second ratio is used to represent another proportional relationship between or among the cache subunits in the cache that comprise the cache lines having different lengths; and
adjusting a quantity of the cache lines in the cache subunit until a difference between the second ratio and the first ratio falls within a range of a preset threshold after the adjustment when the difference between the first ratio and the second ratio is greater than the preset threshold.

4. The method according to claim 1, wherein after receiving the access request, and wherein after determining the data that is to be accessed and that needs to be accessed according to the access request, the method further comprises:
determining, according to the strength level of the spatial locality of the data to be accessed, a size of the data to be cached;
adjusting the length of the cache line in the cache subunit according to the size of the data to be cached;
allocating an adjusted cache line to the data to be cached, wherein a length of the adjusted cache line matches the size of the data to be cached; and
establishing and maintaining an index bitmap based on a change in the length of the cache line in the cache subunit, wherein the index bitmap is used to indicate a tag domain and a data domain that are in the cache line.

5. The method according to claim 1, wherein the multiple cache subunits are disposed in the cache comprises:
dividing the cache by ways and/or by sets, to determine the multiple cache subunits; and
setting the length of the cache line in each of the cache subunits.

6. The method according to claim 4, wherein the access request comprises a physical address, wherein the physical address is used to identify the data to be accessed, wherein the physical address comprises a tag domain and a set domain that are of the data to be accessed, and wherein the method further comprises:
sending the access request to each of the cache subunits;
determining one or more cache lines that correspond to the set domain of the data to be accessed and that are in each of the cache subunits;
comparing tag domains of the one or more cache lines with the tag domain of the data to be accessed; and
determining a cache line, which has a same tag domain as the data to be accessed, in the one or more cache lines as a cache line in which the data to be accessed is stored.

7. The method according to claim 4, wherein the access request comprises a physical address, wherein the physical address is used to identify the data to be accessed, wherein the physical address comprises a tag domain and a set domain that are of the data to be accessed, and wherein the method further comprises:
maintaining a list for each cache subunit, wherein the list is used to record a characteristic value of data stored in each cache subunit;
determining a characteristic value of the data that is to be accessed and that needs to be accessed according to the access request when the access request is received;
determining a cache subunit, which corresponds to a list in which the characteristic value of the data to be accessed is recorded, as a target cache subunit;
sending the access request to the target cache subunit;
determining one or more cache lines in the target cache subunit that correspond to the set domain of the data to be accessed;
comparing tag domains of the one or more cache lines with the tag domain of the data to be accessed; and
determining a cache line, which has a same tag domain as the data to be accessed, in the one or more cache lines as a cache line in which the data to be accessed is stored.

8. A cache management apparatus, wherein the cache management apparatus is configured to manage a cache in which multiple cache subunits are disposed, wherein each cache subunit in the cache comprises multiple cache lines, wherein a length of a cache line comprised in each of the cache subunits is different from a length of a cache line comprised in another cache subunit, wherein each of the cache subunits is configured to store data at a corresponding level, wherein the corresponding level is a strength level of spatial locality of the data, wherein a correspondence between the cache subunit and the corresponding level comprises that the length of the cache line comprised in the cache subunit is in a positive correlation with strength of the spatial locality of the data, and wherein the cache management apparatus comprises:
a readable storage medium; and
a processor coupled to the readable storage medium, and
wherein the readable storage medium is configured to store a plurality of instructions such that when executed by the processor, cause the processor to:
receive an access request;
determine data that is to be accessed and that needs to be accessed according to the access request;
determine a strength level of spatial locality of the data to be accessed; and
allocate, according to the strength level of the spatial locality of the data to be accessed, a cache subunit corresponding to the level to the data to be accessed.

9. The apparatus according to claim 8, wherein the instructions further cause the processor to:
record addresses of data that is to be accessed and that needs to be accessed according to access requests;
collect statistics about access rules of the addresses of the data to be accessed, wherein an access rule comprises a quantity of times or a probability that data of an address adjacent to the addresses is accessed according to another access request; and
classify, into levels according to the quantity of times or the probability that data of the address adjacent to the addresses of the data to be accessed is accessed by another access request, the spatial locality of the data to be accessed.

10. The apparatus according to claim 9, wherein the instructions further cause the processor to:
collect, within a preset time period, the statistics about the strength levels of the spatial locality of the data to be accessed;
calculate a first ratio, wherein the first ratio is used to represent a proportional relationship between or among the data to be accessed having different levels of the spatial locality;
calculate a second ratio, wherein the second ratio is used to represent another proportional relationship between or among the cache subunits in the cache that comprise the cache lines having different lengths; and
adjust a quantity of the cache lines in the cache subunit until a difference between the second ratio and the first ratio falls within a range of a preset threshold after the adjustment when the difference between the first ratio and the second ratio is greater than the preset threshold.

11. The apparatus according to claim 8, wherein the instructions further cause the processor to:
determine, according to the strength level of the spatial locality of the data to be accessed, a size of the data to be cached;
adjust the length of the cache line in the cache subunit according to the size of the data to be cached;
allocate an adjusted cache line to the data to be cached, wherein a length of the adjusted cache line matches the size of the data to be cached; and
establish and maintain an index bitmap based on a change in the length of the cache line in the cache subunit, wherein the index bitmap is used to indicate a tag domain and a data domain that are in the cache line.

12. The apparatus according to claim 8, wherein the instructions further cause the processor to:
divide the cache by ways and/or by sets, to determine the multiple cache subunit; and
set the length of the cache line in each of the cache subunit.

13. The apparatus according to claim 11, wherein the access request comprises a physical address, wherein the physical address is used to identify the data to be accessed, wherein the physical address comprises a tag domain and a set domain that are of the data to be accessed, and wherein the instructions further cause the processor to:
send the access request to each of the cache subunits;
determine one or more cache lines that correspond to the set domain of the data to be accessed and that are in each of the cache subunits;
compare tag domains of the one or more cache lines with the tag domain of the data to be accessed; and
determine a cache line, which has a same tag domain as the data to be accessed, in the one or more cache lines as a cache line in which the data to be accessed is stored.

14. The apparatus according to claim 11, wherein the access request comprises a physical address, wherein the physical address is used to identify the data to be accessed, wherein the physical address comprises a tag domain and a set domain that are of the data to be accessed, and wherein the instructions further cause the processor to:
maintain a list for each cache subunit, wherein the list is used to record a characteristic value of data stored in each cache subunit;
determine a characteristic value of the data that is to be accessed and that needs to be accessed according to the access request when the access request is received;
traverse each list;
determine a cache subunit, which corresponds to a list in which the characteristic value of the data to be accessed is recorded, as a target cache subunit;
send the access request to the target cache subunit;
determine one or more cache lines in the target cache subunit that correspond to the set domain of the data to be accessed;
compare tag domains of the one or more cache lines with the tag domain of the data to be accessed; and
determine a cache line, which has a same tag domain as the data to be accessed, in the one or more cache lines as a cache line in which the data to be accessed is stored.

15. A computer program product comprising a non-transitory computer-readable medium configured to store computer executable instructions, wherein the computer executable instructions comprise instructions for managing a cache in which multiple cache subunits are disposed, wherein each cache subunit in the cache comprises multiple cache lines, wherein a length of a cache line comprised in each of the cache subunits is different from a length of a cache line comprised in another cache subunit, wherein each of the cache subunits is configured to store data at a corresponding level, wherein the corresponding level is a strength level of spatial locality of the data, wherein a correspondence between the cache subunit and the corresponding level comprises that the length of the cache line comprised in the cache subunit is in a positive correlation with strength of spatial locality of the data, and wherein the computer executable instructions further comprise:
instructions for receiving an access request;
instructions for determining data that is to be accessed and that needs to be accessed according to the access request;
instructions for determining a strength level of spatial locality of the data to be accessed; and
instructions for allocating, according to the strength level of the spatial locality of the data to be accessed, a cache subunit corresponding to the level to the data to be accessed.

16. The computer program product according to claim 15, wherein the computer executable instructions further comprise:
instructions for recording addresses of data that is to be accessed and that needs to be accessed according to access requests;
instructions for collecting statistics about access rules of the addresses of the data to be accessed, wherein an access rule comprises a quantity of times or a probability that data of an address adjacent to the addresses is accessed according to another access request; and
instructions for classifying, into levels according to the quantity of times or the probability that data of the address adjacent to the addresses of the data to be accessed is accessed by another access request, the spatial locality of the data to be accessed.

17. The computer program product according to claim 16, wherein the computer executable instructions further comprise:
instructions for collecting, within a preset time period, the statistics about the strength levels of the spatial locality of data to be accessed;
instructions for calculating a first ratio, wherein the first ratio is used to represent a proportional relationship between or among the data to be accessed having different levels of the spatial locality;
instructions for calculating a second ratio, wherein the second ratio is used to represent a proportional relationship between or among the cache subunits in the cache that comprise the cache lines having different lengths; and
instructions for adjusting a quantity of the cache lines in the cache subunit until a difference between the second ratio and the first ratio falls within a range of a preset threshold after the adjustment when the difference between the first ratio and the second ratio is greater than the preset threshold.

18. The computer program product according to claim 15, wherein the computer executable instructions further comprise:
instructions for determining, according to the strength level of the spatial locality of the data to be accessed, a size of the data to be cached;
instructions for adjusting the length of the cache line in the cache subunit according to the size of the data to be cached;
instructions for allocating an adjusted cache line to the data to be cached, wherein a length of the adjusted cache line matches the size of the data to be cached; and
instructions for establishing and maintaining an index bitmap based on a change in the length of the cache line in the cache subunit, wherein the index bitmap is used to indicate a tag domain and a data domain that are in the cache line.

19. The computer program product according to claim 18, wherein the access request comprises a physical address, wherein the physical address is used to identify the data to be accessed, wherein the physical address comprises a tag domain and a set domain that are of the data to be accessed, and wherein the computer executable instructions further comprise:
instructions for sending the access request to each of the cache subunits;
instructions for determining one or more cache lines that correspond to the set domain of the data to be accessed and that are in each of the cache subunits;
instructions for comparing tag domains of the one or more cache lines with the tag domain of the data to be accessed; and
instructions for determining a cache line, which has a same tag domain as the data to be accessed, in the one or more cache lines as a cache line in which the data to be accessed is stored.

20. The computer program product according to claim 18, wherein the access request comprises a physical address, wherein the physical address is used to identify the data to be accessed, wherein the physical address comprises a tag domain and a set domain that are of the data to be accessed, and wherein the computer executable instructions further comprise:
instructions for maintaining a list for each cache subunit, wherein the list is used to record a characteristic value of data stored in each cache subunit;
instructions for determining a characteristic value of the data that is to be accessed and that needs to be accessed according to the access request when the access request is received;
instructions for determining a cache subunit, which corresponds to a list in which the characteristic value of the data to be accessed is recorded, as a target cache subunit;
instructions for sending the access request to the target cache subunit;
instructions for determining one or more cache lines in the target cache subunit that correspond to the set domain of the data to be accessed;
instructions for comparing tag domains of the one or more cache lines with the tag domain of the data to be accessed; and
instructions for determining a cache line, which has a same tag domain as the data to be accessed, in the one or more cache lines as a cache line in which the data to be accessed is stored.
